(19) United States
(12) Patent Application Publication
(10) Pub. No.: US 2008/0265800 A1
(43) Pub. Date: Oct. 30, 2008

(54) Led Lighting Device

(75) Inventor: Pieter Jacob Snijder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,288

(22) PCT Filed: Nov. 14, 2006
(86) PCT No.: PCT/IB2006/054234

§ 371 Date: Jun. 13, 2008

(30) Foreign Application Priority Data
Dec. 16, 2005 (EP) 05112315.6

(51) Int. Cl. H05B 41/36

(52) U.S. Cl. 315/294

(57) ABSTRACT

This invention relates to a LED lighting device having a plurality of LEDs, and a LED drive system. The LED drive system includes basic light circuitry for generating, for each LED, a basic current causing continuous basic light output of the LED. Additionally, the LED drive system includes flash light circuitry, for generating, for each LED, a momentary flash current through the LED, which causes a momentary flash light output. An average current amplitude of the flash current is higher than an average current amplitude of said basic current. Thereby flashes, or twinkles, will be observed by a person watching the LED lighting device.

### FIELD OF THE INVENTION

The present invention relates to a LED lighting device comprising a plurality of LEDs, and a LED drive system.

### BACKGROUND OF THE INVENTION

LED lighting devices are used for many purposes, such as backlighting in a room, floor lighting inside or ground lighting outside, ceiling lamps, and, put together in a large arrangement, as wall screens, etc. Often the LED lighting has a decorative main function. Then, different light effects are desired. A useful light effect is flashing LEDs, i.e. momentarily brighter shining LEDs. For example, this can be utilized for creating an impression of twinkling stars in the sky.

### SUMMARY OF THE INVENTION

It is an object of the present invention to provide a LED lighting device, which is able to provide a flashing light.

This object is achieved by a LED lighting device according to the present invention as defined in claim 1.

Thus, in accordance with an aspect of the present invention, there is provided a LED lighting device comprising a plurality of LEDs, and a LED drive system, which comprises basic light circuitry and flash light circuitry connected to the LEDs. For each LED, the basic light circuitry is arranged to generate a continuous basic light output by generating a basic current through the LED, and the flash light circuitry is arranged to generate a momentary flash light output by generating a flash current through the LED during a limited time period, wherein an average current amplitude of said flash current over said limited time period is higher than an average current amplitude of said basic current over an equally long time period.

By momentarily, i.e. during a short time period, driving the flash current through a LED, the LED is temporarily lit up in a way that is perceived as sparkling. This drive current method is unexpected in that typically the basic current is about the nominal current of the LED, and then the mere thought of overloading the LED would be reluctant to a person skilled in the art. However, it has shown to be unjustified apprehensions, due to the momentary nature of the flash current. Additionally, the basic current can be chosen lower than the nominal current, thereby making sparkling effects possible at or below nominal current.

Further, the LED drive system can provide any known type of drive current to the LEDs, e.g. continuous current or pulsed current, and different parts of the LED drive system can provide different types of drive current.

The basic light circuitry and the flash light circuitry, including the capacitor circuitry are connected to the LEDs. When the flash currents are generated in the LEDs they can be added to as well as replacing the basic currents. The flash current can be generated separately or as an increase of the basic current.

In accordance with an embodiment of the LED lighting device as defined in claim 2, a capacitor discharge is used for generating the flash current. Thereby basic drive properties can be employed most of the time, except for the short moments when the flash current is generated through the LED by means of the discharge.

In accordance with an embodiment of the LED lighting device as defined in claim 3, the discharge current is superposed on the basic drive current, which is the ordinary drive current. It should be noted that the level of the basic current is optional. Typical current values range from zero to nominal value.

In accordance with embodiments of the LED lighting device as defined in claims 5, and 6, the capacitor circuitry provides either one capacitor for each LED or one capacitor per several LEDs. These different embodiments have different advantages. For example, an advantage of providing one capacitor per LED is that the flash rate per LED can be higher as the capacitor is not discharged by other LEDs. On the other hand, several LEDs sharing the same capacitor contribute to preventing LED overload.

In accordance with an embodiment of the LED lighting device as defined in claim 7, LED currents in excess of the nominal current level are used. This is possible due to the momentary character of the flashlight. Additionally, different LED overload protections can be provided, as defined in claim 12.

In accordance with embodiments of the LED lighting device as defined in claims 8 and 9, the drive current to each LED is directly controlled in order to obtain the different types of current pulses associated with basic light output and flash light output, respectively.

In accordance with an embodiment of the LED lighting device as defined in claim 10, a separate switched flash current source is provided for generating the flash current.

These and other aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 schematically shows an example of a LED lighting device;

FIG. 2 shows a schematic block diagram of a portion of a LED drive system for a LED lighting device according to a first embodiment of the present invention;

FIG. 3a shows a schematic block diagram of a portion of a LED drive system for a LED lighting device according to a second embodiment of the present invention;

FIG. 3b is a diagram illustrating basic and flash currents in the second embodiment;

FIG. 4a shows a schematic block diagram of a portion of a LED drive system for a LED lighting device according to a third embodiment of the present invention;

FIG. 4b is a diagram illustrating basic and flash currents in the third embodiment;

FIG. 5a shows a schematic block diagram of a portion of a LED drive system for a LED lighting device according to a fourth embodiment of the present invention; and

FIG. 5b is a diagram illustrating basic and flash currents in the fourth embodiment.

### DESCRIPTION OF PREFERRED EMBODIMENTS

A lighting device 1 comprises a LED carrier 3 and a plurality of, for example 16, LEDs 5. The LEDs 5 are arranged in a matrix. The LED lighting device can be used, for example, as a LED lamp or a decorative element.

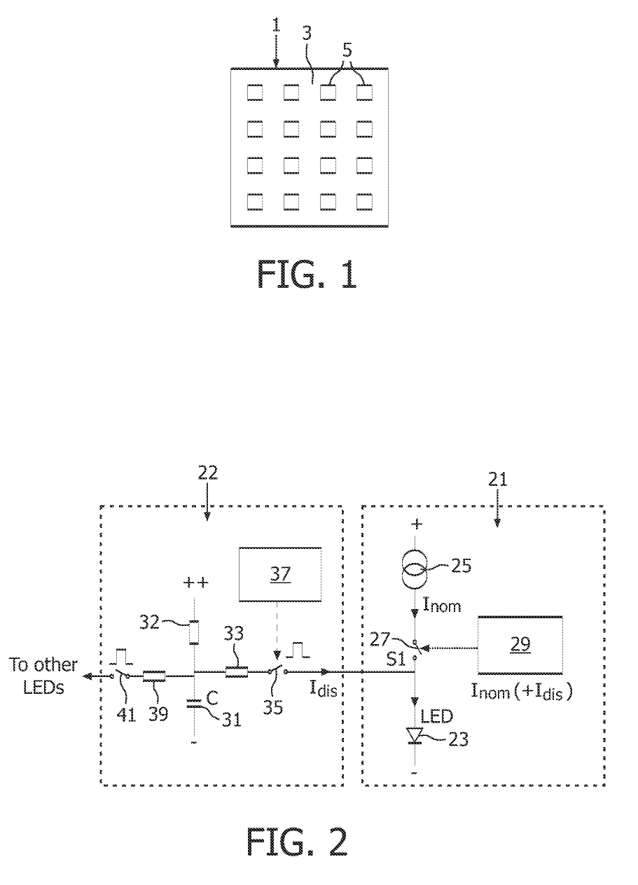

Referring to FIG. 2 a portion of a LED drive system for driving the LED lighting device 1 is shown. A single LED 23 is shown, but the other LEDs are similarly connected. The LED drive system comprises a basic light circuitry 21, which is a basic power supply system, including, for each LED, a current source 25, a current switch 27, and a basic current controller 29. The current source is connected to the LED 23 via the current switch 27 and generates a basic current through the LED 23. The current switch 27 is switched on and off by the basic current controller 29. The current source 25 drives the LED 23 at nominal current Iₙₒₘ. In order to enable for example intensity adjustment capability, the LED 23 is driven by means of pulse width modulation PWM of the drive current, i.e. the basic current is provided as current pulses. The pulse duration (width) is controlled by means of the basic current controller 29.

Further, the LED drive system comprises a flash light circuitry 22 comprising a capacitor circuitry, which is connected to the LED 23, and to the other LEDs 5 of the lighting device 1. The capacitor circuitry comprises a capacitor 31, a load resistor 32, which is connected between the capacitor 31 and the positive supply voltage, and a discharge resistor 33, which is connected, at one end, to a junction between the capacitor 31 and the charge resistor 32, and at the other end to the anode of the LED 23. Thus, from a discharge view, the discharge resistor 33 is series connected with the LED 23. A discharge switch 35 is connected between the first resistor 33 and the LED 23. A discharge controller 37 is connected to the discharge switch 35.

The capacitor 31 is charged via the charge resistor up to a voltage that exceeds the nominal voltage across the LED 23, i.e. the voltage that appears across the LED when fed with the nominal current Iₙₒₘ. When the discharge switch 35 is closed by the discharge controller 37, the capacitor 31 is discharged over the first resistor 33 and the LED 23, thereby generating a discharge current I_{dis} through the LED 23. Since both switches 27, 35 are connected in common to the LED 23, the discharge current I_{dis} is superposed on the basic current, i.e. the nominal current Iₙₒₘ. When the discharge switch 35 is closed the current switch 27 may be closed as well, but it may be open too. The discharge current causes a sudden increase in brightness of the light emitted from the LED 23. During the discharge the charge of the capacitor 31 will drop rapidly, causing a simultaneous decrease of the light output, until the capacitor voltage reaches the nominal voltage across the LED 23.

The discharge resistor 33 limits the discharge current I_{dis}, whereas the charge resistor 32 limits the charge current, and thus controls the charging time, which in turn limits the flash frequency. Due to these limitations, thermal overload of the LED 23 is avoided. Thus the resistors constitute overload protection devices.

In this embodiment the capacitor 31 is used for supplying discharge currents to more than one LED. This is indicated in FIG. 2 by the additional discharge resistor 39 and the additional discharge switch 41, which are connected to another LED, not explicitly shown. That LED is provided with a basic power supply system equal to that shown in FIG. 2.

In an alternative embodiment each capacitor serves a single LED. Should there be a desire of simultaneous flashing of neighboring LEDs, they should be served by respective individual capacitors.

As an alternative to PWM and other pulsed current techniques, the basic current switch can be omitted or closed over a long time period, causing a continuous basic current through the LED 23. The current amplitude may then be variable.

In any case the basic light circuitry provides a basic light output that will be perceived as continuous by a person looking at the LED 23.

In one application, the plural LEDs 5 of the lighting device 1 are arbitrarily fed with the flash currents in order to obtain a glittering effect. Further, several lighting devices can be mounted adjacent to each other in a geometric pattern, such as a square, in order to obtain a large flashing surface. On the other hand, the flashing can be synchronized so as to provide a simultaneous flashing of all LEDs, or rows of LEDs flashing consecutively.

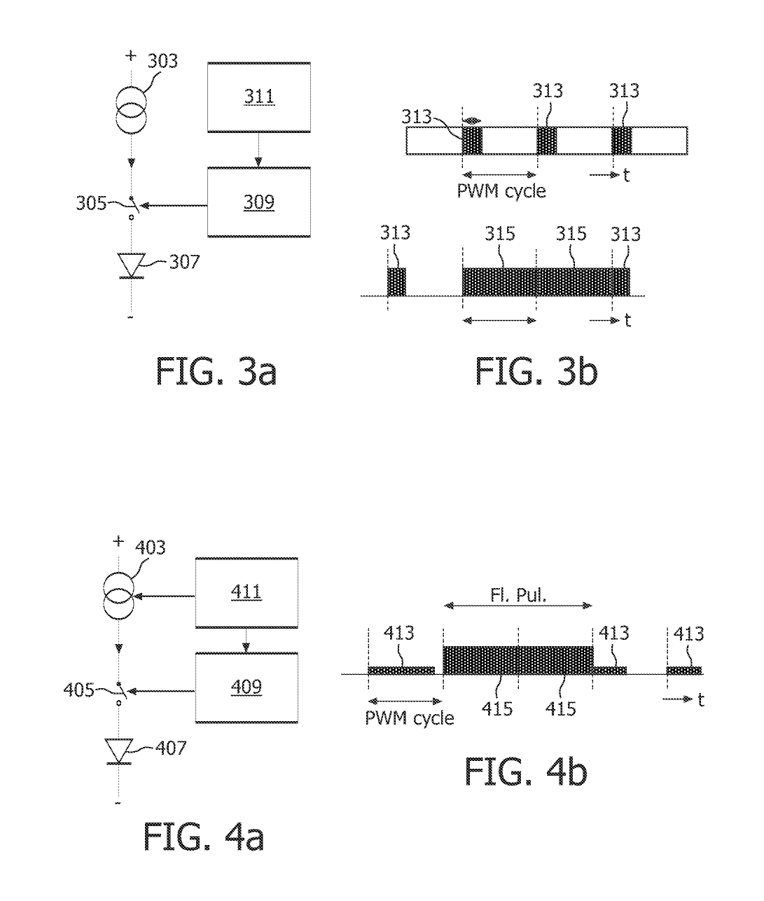

As shown in FIG. 3a, in a second embodiment of the LED lighting device 1, for each LED there is a single current source 303, connected via a single current switch 305 to the LED 307. The basic light circuitry comprises a basic current controller 309, which is connected to the current switch 305 for cyclically generating basic current pulses. This second embodiment uses PWM. A flash current controller 311 is connected to the basic current controller 309. The amplitude of all current pulses is the same. The amplitude is much higher than the nominal current, for example 2-10 times as high. The duration of the basic current pulses 313 is chosen such that the average current does not exceed the nominal current of the LED 307. Thereby overload of the LED 307 is prevented. As shown in FIG. 3b, the basic current controller controls the current switch 305 such that a basic current consisting of basic current pulses 313 of a first duration, which is a fraction of a PWM cycle, are generated. The flash current controller 311 is superior of the basic current controller and arbitrarily forces the basic current controller to prolong the time that the current switch 305 is closed. Thereby a flash pulse train containing one or more pulses 315 of a second duration, which is considerably longer than the first duration, is generated. Here the flash pulse train consists of two flash current pulses 315 the duration of which corresponds to the full PWM cycle. Alternatively, this can be regarded as a single pulse having a two PWM cycle duration. To the contrary of the basic current pulses 313, the flash current pulses 315 cause a temporary overload of the LED. However, as long as a maximum current is not exceeded and the duration of this overload state is not too long, the LED 307 still does not become damaged.

A third embodiment of the LED lighting device is shown in FIG. 4a. It is similar to the second embodiment, and has a current source 403, connected via a current switch 405 to a LED 407, a basic current controller 409, and a flash current controller 411. However, in addition to its connection to the basic current controller 409 the flash current controller has a connection to the current source 403. Thereby, in addition to controlling the pulse duration, the flash current controller 411 controls the amplitude of the supply current. Typically, as seen in FIG. 4b, the duration of the flash current pulses 415 is made longer and the amplitude is made higher than the duration and amplitude, respectively, of the basic current pulses 413. During flash pulses the flash current controller 411 controls the basic current controller 409 so as to keep the current switch 405 closed.

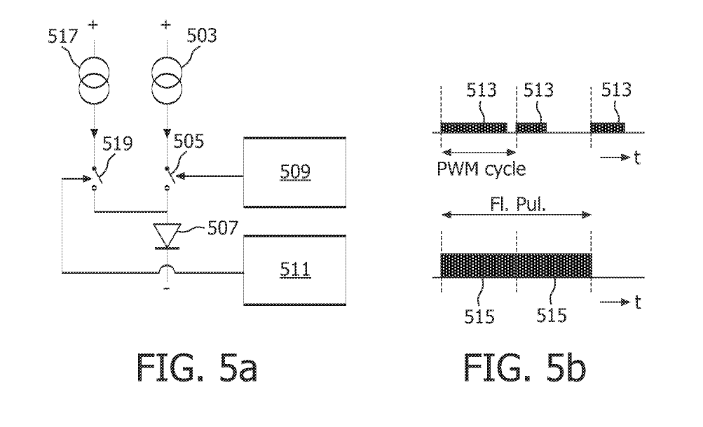

A fourth embodiment of the LED lighting device is shown in FIG. 5a. It has a basic current source 503, connected via a basic current switch 505 to a LED 507, and a basic current controller 509. Further this fourth embodiment comprises a flash current source 517, a flash current switch 519, which is connected to the LED 507, and a flash current controller 511, which controls the flash current switch 519. Thus, similar to the first embodiment the flash current is generated separately and superposed on the basic current, as shown in FIG. 5b. The duration and amplitude of the flash pulses are chosen such that a desired effect is obtained while preventing damaging overload of the LED 507. Typically, the amplitude of the flash pulses 515 is several times higher than the amplitude of the basic pulses 513, and the duration is longer, typically a full PWM cycle.

In all embodiments the flash current controller can be used as an overload protection device, since it is optionally programmable. Further, the current sources as such can be used as protection devices, since the maximum currents of the current sources can be appropriately limited in order to prevent, or at least contribute to preventing, overload.

Above, embodiments of the LED lighting device according to the present invention have been described. These should be seen as merely non-limiting examples. As understood by a skilled person, many modifications and alternative embodiments are possible within the scope of the invention.

Thus, as explained by means of the embodiments above, by using flash light circuitry for generating flash currents through the LEDs, momentary current increases through the LEDs, which may constitute overloads, causes temporarily increased brilliance in the light emitted from the LEDs, which is recognized as flashes or twinkles by a person watching the LED lighting device. The duration of the possible overloads is short enough for avoiding damages on the LEDs, and the overall power consumption is but little increased.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. A LED lighting device comprising a plurality of LEDs, and a LED drive system, which comprises basic light circuitry and flash light circuitry connected to the LEDs, wherein, for each LED, said basic light circuitry is arranged to generate a continuous basic light output by generating a basic current through the LED, and said flash light circuitry is arranged to generate a momentary flash light output by generating a flash current through the LED during a limited time period, wherein an average current amplitude of said flash current over said limited time period is higher than an average current amplitude of said basic current over an equally long time period.

2. A LED lighting device according to claim 1, wherein said flash light circuitry comprises capacitor circuitry connected to the LEDs, wherein, for each LED, said capacitor circuitry is arranged to provide a discharge, which is applied to the LED for generating said flash current.

3. A LED lighting device according to claim 2, wherein said flash current is obtained by superposing a discharge current, resulting from said discharge, on the basic current.

4. A LED lighting system according to claim 1, wherein said flash light circuitry further comprises flash control means, controlling the supply of said flash current to the LED.

5. A LED lighting system according to claim 2, wherein said capacitor circuitry comprises one capacitor for each LED.

6. A LED lighting system according to claim 2, wherein said capacitor circuitry comprises a plurality of capacitors, wherein each capacitor thereof is connected to several LEDs.

7. A LED lighting system according to claim 1, wherein the amplitude of said flash current is higher than the amplitude of a nominal current of the LED.

8. A LED lighting device according to claim 1, wherein, for each LED, said LED drive system comprises a current source connected with the LED via a current switch, wherein said basic light circuitry comprises a basic current controller controlling said current switch for cyclically generating basic current pulses, constituting said basic current, and wherein said flash light circuitry comprises a flash current controller controlling said current switch for generating a flash pulse train, containing at least one flash current pulse, constituting said flash current, wherein the flash current controller is superior to the basic current controller, and is arranged to increase the duration of the flash current pulse in relation to the duration of the basic current pulse.

9. A LED lighting device according to claim 8, wherein said flash current controller is further connected to the current source and is arranged to increase the amplitude of the flash current pulses in relation to the amplitude of the basic current pulses.

10. A LED lighting device according to claim 1, wherein, for each LED, said LED drive system comprises a basic current source connected with the LED via a basic current switch, and a flash current source connected with the LED via a flash current switch, wherein said basic light circuitry comprises a basic current controller controlling said basic current switch for cyclically generating basic current pulses, constituting said basic current, and wherein said flash light circuitry comprises a flash light controller controlling said flash current switch for generating a flash pulse train, containing at least one flash current pulse, constituting said flash current.

11. A LED lighting system according to claim 8, wherein the amplitude of said flash current pulses is higher than the amplitude of a nominal current of each one of said LEDs.

12. A LED lighting system according to claim 1, further comprising a LED overload protection device.
